(19) United States
(12) Patent Application Publication
(10) Pub. No.: US 2016/0076482 A1
(43) Pub. Date: Mar. 17, 2016

(54) INTEGRATED ELECTRICITY GENERATING DEVICE AND HOT WATER BUFFER TANK

(71) Applicant: Erez Harel, Misgav (IL)

(72) Inventor: Erez Harel, Misgav (IL)

(21) Appl. No.: 14/483,296

(22) Filed: Sep. 11, 2014

(51) Int. Cl. F02G 1/053; F24H 1/20

(52) U.S. Cl. CPC F02G 1/053; F24H 1/206; F23J 2211/00

(57) ABSTRACT

An integrated μCHP electricity generating device and water storage buffer tank is combined into a single system and allows for the simultaneous generation of electric power and the production of hot water in a single system at a minimal foot print and increased energy efficiency.

### CROSS-REFERENCE TO OTHER APPLICATIONS

This application claims priority from U.S. Provisional Patent Application 61/876,840, filed Sep. 12, 2013.

### FIELD OF THE INVENTION

The present invention relates to an integrated design of heat and power generator and buffer tank and more particularly, to the coexistence of the generator and water buffer tank both inside a shared vessel.

### BACKGROUND OF THE INVENTION

A micro CHP (combined heat and power—μCHP) system is a heat and power device that simultaneously generates electricity and useful heating from the combustion of a fuel or other source of thermal energy. In traditional light-commercial and/or industrial hot water systems, a buffer tank is usually utilized as a secondary thermal energy storage element situated directly next to the primary boiler. This buffer tank or hot water storage tank stabilizes the heat production profile of the primary boiler by providing increased heat storage that can be used in times of peak thermal demand, a necessary feature in most commercial and industrial applications. The typical available space around such a multiple tank heating system is often very minimal which prevents the connection and use of additional pieces of equipment. This foot-print restriction is a serious factor in heating system architecture and one which hinders the integration of additional equipment, such as electricity generating μCHP devices, in many of these light commercial and industrial heating applications.

Reference is made to FIG. 1, which illustrates a prior art μCHP connected to a standard water heating setup where a recuperator 1 serves as an interface between a μCHP device 3 and buffer tanks 4 and 5. The electrical power is transferred to the grid via an inverter 2.

### SUMMARY

The present invention overcomes limitations of the prior art by providing a means by which a μCHP system can be beneficially integrated into the traditional style heating system architecture without needing to expand the amount of dedicated floor space for the heating system which might be impossible or very costly at best. The present invention allows for the seamless integration of both the electricity generating μCHP device and thermal storage water tank into one single structural unit using the same floor-space, enabling the cogeneration of hot water and electric power at power levels greater than 500 Watts for commercial, residential and industrial applications. The generated power could then be used locally and/or sold back to the utility company. The μCHP device is powered by combustion of a fuel, which may be the sole source of heat in the device.

The present invention seeks to overcome the size and shape hurdles which limit the usage of μCHP devices as separate stand-alone systems in preexisting or new commercial water heating installations (as shown in the prior art of FIG. 1). In terms of available volume, a light commercial μCHP device based on a Stirling cycle engine, but not limited to this engine, has a comparable foot print to that of a light commercial buffer tank also known as a hot water storage tank. The present invention provides a means to combine these two systems by integrating the μCHP device inside the buffer tank structure. The μCHP device is integrated into the tank in such a way that the exhaust from the μCHP burner is directed into the buffer tank such that the thermal energy of the exhaust is directly absorbed into the water buffer tank. The integration of these two systems within a single structure at close proximity allows all the rejected heat energy from the electricity generating device to be directly absorbed in the buffer tank and thus efficiently utilize the otherwise wasted heat, thereby further improving the overall system efficiency. In addition, the buffer tank structure and casing provides the necessary support structure to hold the μCHP device and protect it, respectively.

In one non-limiting embodiment, the μCHP device is integrated on top of the water tank but within the buffer tank casing such that the combustion chamber of the μCHP exhaust is directed into a helical heat exchanger, also known as an exhaust gas recuperator, submerged within the water of the buffer volume. Not only does this provide for significant floor space saving, the user would possess a single seamless unit which would prevent complex integration between various inter-dependent components. Another benefit is to employ the inherent mass of the water tank including its contained water to further attenuate any exported vibration from the μCHP device. Most μCHP devices are relatively quiet, but may have some mechanical parts which can potentially create some vibration export. The water tank serves to further attenuate the unit's exported vibrations.

Additionally, the device vibrations enhance the heat transfer into the fluid, while minimizing heat leaks to the environment.

By using this arrangement the system also utilizes the heat generated in the piston compression space, and keeps the piston alternator assembly from overheating, while reducing the piping and accompanied connectors found in traditional systems.

To summarize, by employing this novel concept of integrating the μCHP device into the water buffer tank structure the end user realizes at least the following benefits:
1. Power Generation and Hot Water Storage on Pre-Existing Floor Space: The unit integration obviates any need to expand floor space when adding electricity generation capacity to a pre-existing or newly installed water heating system.
2. More Efficient Operation: The close proximity of the electricity generating device to the thermal sink in the water improves the heat transfer. The rejected heat from the μCHP device is directly absorbed into the water at minimum energy loss to the surrounding environment, hence improving overall system efficiencies.
3. Cost Reduction: Employing a single structure and casing to provide support and protection for both units saves the additional cost of two separate structures and casings.
4. Highly Attenuated Vibration Export: By joining the μCHP device, which is based on a thermo-mechanical device and having inherent vibration, to the same structure as the water storage tank provides significant extra mass, stabilization and damping of the exported vibration. The vibration enhances convective heat transfer to increase cooling of the drive train and electromagnetic components such as the alternator and the piston compression space.

### BRIEF DESCRIPTION OF THE DRAWINGS

The present invention will be understood and appreciated more fully from the following drawings:

FIG. 1 is a simplified illustration of a prior art μCHP connected to a standard water heating setup;

FIG. 2 is a simplified illustration of an electricity generating device (combined heat and power system), constructed and operative in accordance with a non-limiting embodiment of the present invention; and

FIG. 3 is a simplified illustration of an electricity generating device (combined heat and power system), constructed and operative in accordance with another non-limiting embodiment of the present invention.

### DETAILED DESCRIPTION OF EMBODIMENTS

Reference is now made to FIG. 2, which illustrates a system with the innovative concept in which the μCHP device (engine) 10 is integrated within a volume of a buffer tank 15. Engine 10 generates both electric power and hot water. The water in tank 15 is in direct contact with, and absorbs heat from, engine 10 (as indicated by reference numeral 15A). The engine 10 is partially or fully submerged in the water. The domestic hot water enters the tank at an inlet 11, heats up and leaves the tank hot at an outlet 12. A recuperator 13 further collects exhaust thermal energy from engine 10 (e.g., flue gas heat resulting from combustion of the fuel for the engine) and transfers the exhaust thermal energy to tank 15. The electric power is transferred to an external user (e.g., grid) via a power inverter 14.

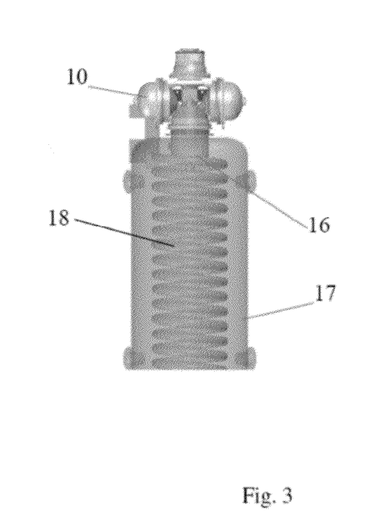

In FIG. 3 another embodiment is shown in which the μCHP device 10 is integrated into a buffer tank 17 by having an exhaust gas recuperator 18 serve as an integral part of the water tank 17. Hot flue gas travels from a burner component 16 of engine 10 via a helical recuperating heat exchanger 18 into the water of buffer tank 17 and heats up the water in buffer tank 17. The hot water leaves through an exit pipe 18. Electricity is generated and diverted to the grid through the power inverter 14 (shown in FIG. 2).

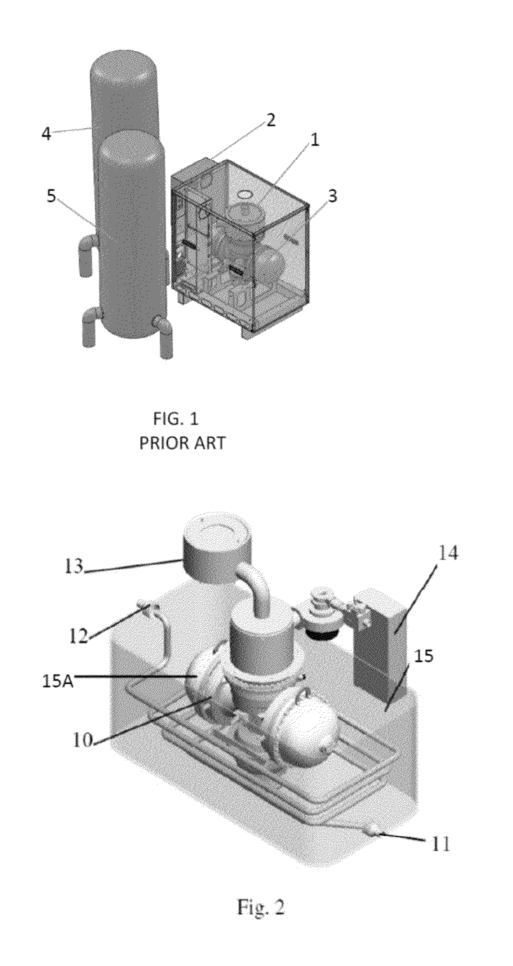

In the prior art system of FIG. 1, the μCHP 1 and boiler tank 4 “feed” the buffer tank 5 with hot water. The buffer tank releases the hot water to the customer. In contrast, in the embodiment of FIG. 2, the μCHP 10 is submerged in the buffer tank 15 and produces electricity in conjunction with heating the water in the buffer tank 15 respectively. In the embodiment of FIG. 3, the μCHP device 10 flue gas runs out from the burner 16 into the helical recuperator 18 hence heating up the buffer tank 17 which releases the now hot water to the consumer. The μCHP also produces electricity.

What is claimed is:

1. An electricity generating device comprising:
a buffer tank comprising a water inlet and a water outlet and having water disposed therein;
a micro combined heat and power (μCHP) engine at least partially submerged in the water of said buffer tank, said engine operative to generate electric power and heat water, wherein the water of said buffer tank is arranged to absorb heat from said engine; and
a power inverted operative to transfer the electric power from the engine to an external user.

2. The electricity generating device according to claim 1, wherein said engine is fully submerged in the water of said buffer tank.

3. The electricity generating device according to claim 1, wherein said engine is powered by combustion of a fuel.

4. The electricity generating device according to claim 1, further comprising a recuperator operative to collect exhaust thermal energy from said engine and transfer said exhaust thermal energy to said buffer tank.

5. The electricity generating device according to claim 1, wherein said engine comprises a Stirling cycle engine.

6. The electricity generating device according to claim 3, wherein the combustion of said fuel is the sole source of heat into the electricity generating device.

7. The electricity generating device according to claim 3, wherein hot flue gas resulting from the combustion of said fuel travels from a burner component of said engine via a helical recuperating heat exchanger into the water of said buffer tank.

8. The electricity generating device according to claim 1, wherein vibrations from said engine are attenuated in the water of said buffer tank and increase convective heat transfer from said engine to the water.
